(19) United States
(12) Patent Application Publication
(10) Pub. No.: US 2007/0068028 A1
(43) Pub. Date: Mar. 29, 2007

(54) Optical cleaning device

(75) Inventors: Ming-Chich Chung, Xinzhuang City (TW); Chien-Fu Chen, Xinzhuang City (TW); Walong Sheu, Xinzhuang City (TW); Yan-Gu Lai, Xinzhuang City (TW); Ace Lin, Xinzhuang City (TW); Chiung-Hui Chen, Xinzhuang City (TW); Hsien-Chung Chiu, Xinzhuang City (TW)

Correspondence Address: LEONG C LEI, PMB # 1008, 1867 YGNACIO VALLEY ROAD, WALNUT CREEK, CA, 94598, US

(73) Assignee: MICRO-DIGITAL AUTOMATION CORP.

(21) Appl. No.: 11/324,282

(22) Filed: Jan. 4, 2006

(30) Foreign Application Priority Data
Sep. 28, 2005 (TW) 094216669

(51) Int. Cl. F26B 17/30; F26B 5/08

(52) U.S. Cl. 34/58; 34/312

(57) ABSTRACT

A novel cleaning device for removing the particles and residual chemicals from the surfaces of optical objects is provided herein. The cleaning device mainly integrates a driving mechanism for spinning the object to be cleaned, and an advancing mechanism to lift the object in and out of the cleaning device. The driving mechanism has adjustment means for adjusting the level of the object so that the object could be rotated at very high speed but with superior stability. The advancing mechanism reduces manual intervention in the cleaning process and thereby reduces the possibility of contamination to the object after it is cleaned.

### BACKGROUND OF THE INVENTION

(a) Technical Field of the Invention

The present invention generally relates to optical cleaning devices, and more particularly to a device which utilizes the centrifugal force to remove particles and residual chemicals from the surface of an optical object

(b) Description of the Prior Art

As liquid crystal display (LCD) has become the mainstream display technology, the demand for high quality auxiliary components such as diffusion films, prism films has arisen rapidly. A large number of manufacturing techniques for these optical films or devices have been disclosed in the related arts such as ink-jet printing or roll-to-roll printing.

These devices usually require a cleaning process during their fabrication to remove the particles and residual chemicals from their surfaces. This is a key to the quality of the manufactured products. Conventionally, a cleaning device for these optical objects relies on spinning and detergent. However, the conventional cleaning device has a number of problems. For example, the balance or level of the object to be cleaned would deviate from the ideal configuration after an extended period of use. The rotation of the object therefore suffers vibrations when the rotational speed reaches a certain level. In the worst case, the delicate and costly object would be damaged. Additionally, there is usually no elevating mechanism to lift the object in and out of the cleaning device, making the cleaning process more troublesome.

### SUMMARY OF THE INVENTION

The primary purpose of the present invention is to provide a novel cleaning device for removing the particles and residual chemicals from the surfaces of optical objects is provided herein. The cleaning device mainly integrates a driving mechanism for spinning the object to be cleaned, and an advancing mechanism to lift the object in and out of the cleaning device.

The driving mechanism has adjustment means for adjusting the level of the object when it is placed in the cleaning device so that the object could be rotated at very high speed but with superior stability.

The advancing mechanism reduces manual intervention in the cleaning process and thereby reduces the possibility of contamination to the object after it is cleaned.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the outlook of an embodiment of the present invention.

FIG. 2 is a perspective explosive view showing the various components of the optical cleaning device of FIG. 1.

FIG. 3 is a side view showing the optical cleaning device of FIG. 1.

FIG. 4 is a partially enlarged view showing the optical cleaning device of FIG. 1.

FIG. 5 is a cross-sectional view showing the matching of the shaft sleeve and the shaft of the optical cleaning device of FIG. 1.

FIG. 6 is a top viewing showing the optical cleaning device of FIG. 1.

FIG. 7 is a side view showing the vertical movement of the shaft of the optical cleaning device of FIG. 1.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

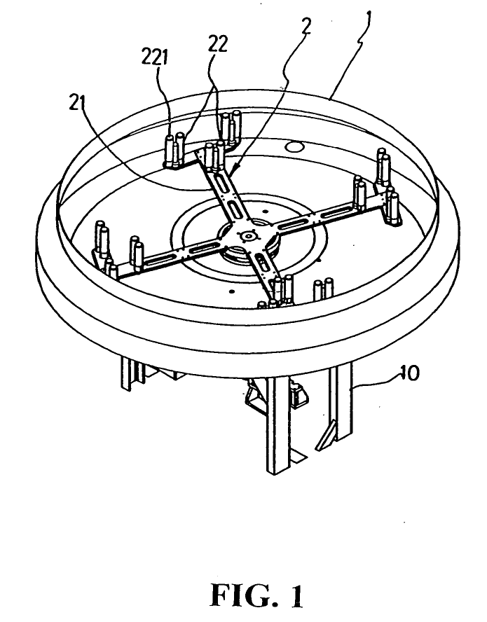

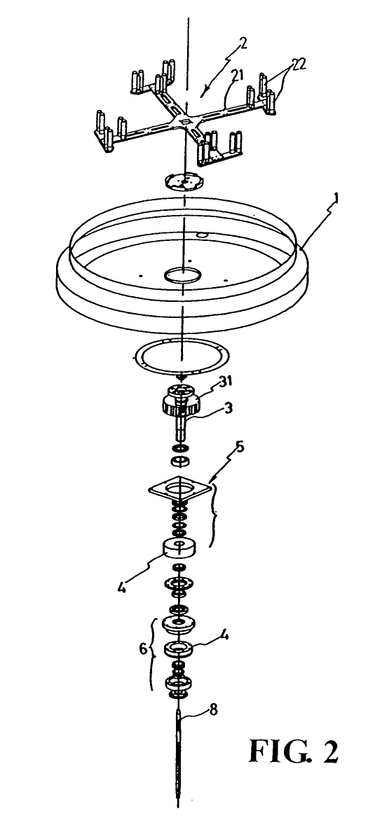

As shown in FIGS. 1˜3, an embodiment of the present invention mainly contains a hollow disc 1, an X-shaped stand 2, a shaft sleeve 3, an upper and a lower core adjuster 4, an upper seat 5, a lower seat 6, a driving mechanism 7, a shaft 8, and an advancing mechanism 9. The stand 2 is fixedly attached to an end of the shaft 8 so that, when the shaft 8 is rotated axially, the stand 2 is rotated as well. The X-shaped stand 2 contains a number of arms 21 extended from the center. At the outer ends of the arms 21, there are a number of supporting rods 22 configured perpendicularly from the arms 21. At the top end of each supporting rod 22, there is an acid-proof and alkaline-proof plastic pad 221. The object to be cleaned by the present embodiment is laid flatly on the plastic pads 221.

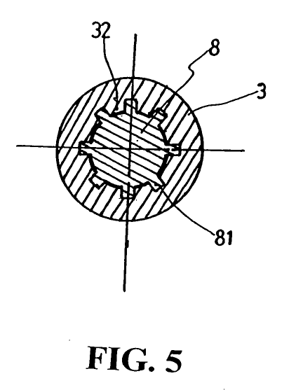

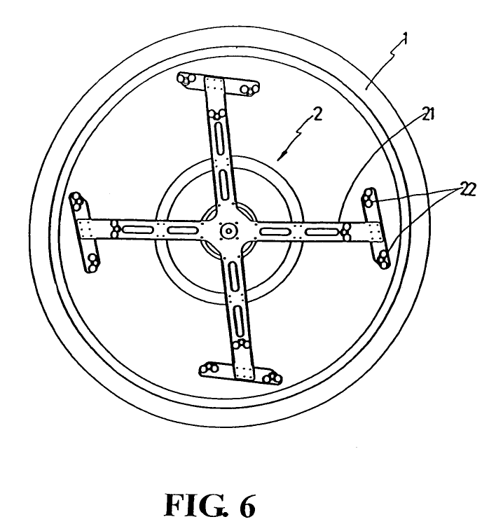

Please also refer to FIG. 6. The stand 2 is housed inside the disc 1 during the cleaning process. Right beneath the center of the disc 1, the upper seat 5 is fixedly installed to the bottom of the disc 1. The upper core adjuster 4 in turn is fixedly installed to the bottom of the upper seat 5. Both the upper seat 5 and the upper core adjuster 4 have aligned center through holes (not numbered) allowing the shaft 8 to pass through so as to join to the stand 2. Right between the upper core adjuster 4 and the lower seat 6, the shaft sleeve 3 is configured. The circumference of the shaft sleeve 3 has a number of axial teeth 31 matching the teeth on a crawler belt 71 of the driving mechanism 7. As shown in FIG. 5, on the inner wall of the shaft sleeve 3, there are axial flutes 32 matching the axial teeth 81 of the shaft 8. As such, the shaft sleeve 3 is rotated by the crawler belt 71 of the driving mechanism 7, which in turn drives the shaft 8 and thereby the stand 2 to spin.

As shown in FIG. 4, the lower seat 6 is installed below the shaft sleeve 3. The lower core adjuster 4 is configured inside the lower seat 6. The upper and lower core adjusters 4 are used to adjust the verticality of the shaft 8 and thereby the level of the stand 2.

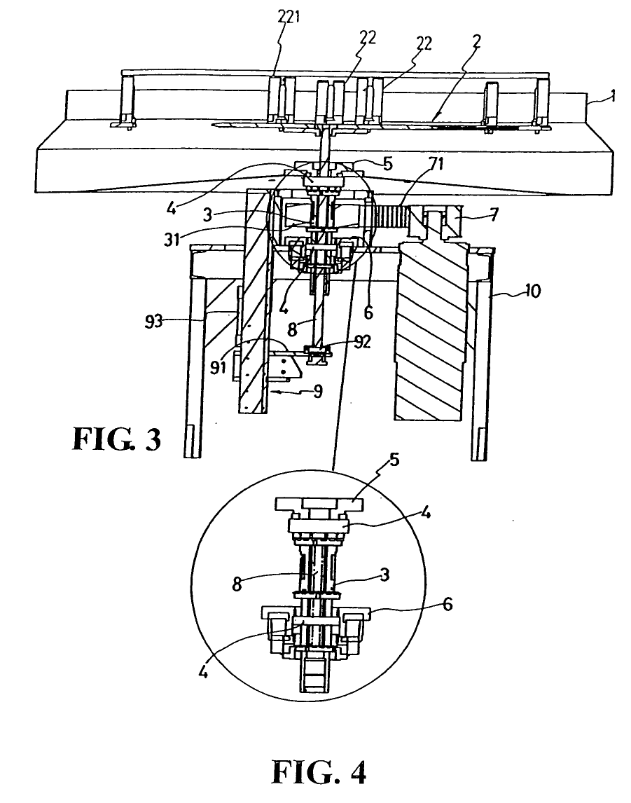

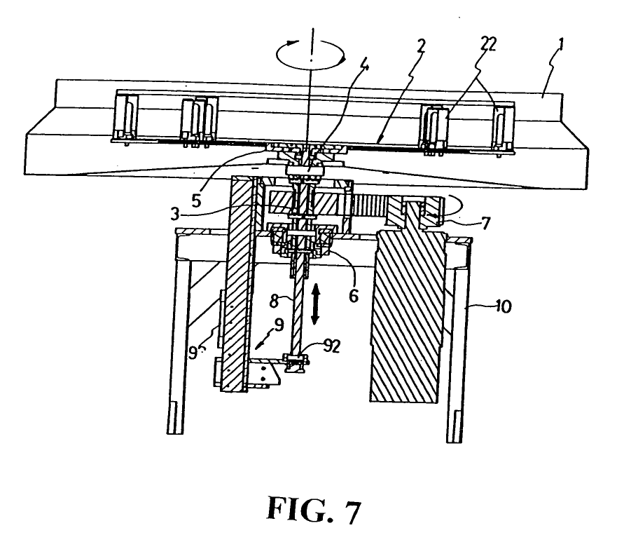

As shown in FIG. 3, the bottom end of the shaft 8 is connected to an arm 91 extended from the advancing mechanism 9 via a bearing 92 configured at the bottom of the shaft 8. As such the spinning of the shaft 8 wouldn't be interfered by the arm 91 and the advancing mechanism 9. The arm 91 is connected to a moving device 93 which utilizes air pressure to move the arm 91 vertically up or down, which in turn lift the shaft 8 and thereby the stand 2 up or down, as shown in FIG. 7.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An optical cleaning device comprising:
a hollow disc;
a shaft having axial teeth;
a stand housed inside said disc and fixedly attached to the top end of said shaft so that said stand spins along said shaft, said stand comprising a plurality of supporting rods extended vertically from said stand to support an object to be cleaned;
an upper seat and an upper core adjuster fixedly installed to the bottom of said disc having aligned center through holes allowing said shaft to pass through;
a lower seat and an lower core adjuster located at an appropriate distance below said upper seat and said upper core adjuster having aligned center through holes allowing said shaft to pass through, said upper and lower core adjusters providing adjustment to the verticality of said shaft;
a shaft sleeve located beneath said upper seat and said upper core adjuster and above said lower seat and said lower core adjuster, said shaft sleeve allowing said shaft to pass through and having a plurality of axial flutes along the inner wall matching said axial teeth of said shaft;
a driving mechanism linked to said shaft sleeve by an appropriate means to deliver rotational force to said shaft sleeve which in turn drives said shaft to spin; and
an advancing mechanism linked to the bottom end of said shaft by an appropriate means to deliver vertical moving force to said shaft which in turn lifts said stand up and down.

2. The optical cleaning device according to claim 1, wherein the top end of each said supporting rod has an acid-proof and alkaline-proof plastic pad.

3. The optical cleaning device according to claim 1, wherein said driving mechanism uses a crawler belt to link to said shaft sleeve; and said shaft sleeve has a plurality of axial teeth along the circumference of said shaft sleeve matching the teeth of said crawler belt.

4. The optical cleaning device according to claim 1, wherein said advancing mechanism is linked to the bottom end of said shaft via a bearing.
